(19) United States
(12) Patent Application Publication
(10) Pub. No.: US 2011/0066640 A1
(43) Pub. Date: Mar. 17, 2011

(54) METHOD FOR PROCESSING COMBINED TEXT INFORMATION

(76) Inventor: Chun Ki Kim, Gyeonggi-do (KR)

(21) Appl. No.: 12/992,589

(22) PCT Filed: Feb. 19, 2009
(86) PCT No.: PCT/KR09/00790

§ 371 Date: Nov. 12, 2010

(30) Foreign Application Priority Data
May 13, 2008 (KR) 10-2008-0043996

(51) Int. Cl. G06F 17/30; G06F 15/16

(52) U.S. Cl. 707/769; 709/206; 707/E17.014

(57) ABSTRACT

Provided is a combined text information processing method including: at a combined text information processing system, registering a member by receiving member information containing a member ID and a phone number for message transmission on the member ID; at a user, sending combined text information to the combined text information processing system through a network; at a receiver section of the combined text information processing system, receiving the combined text information; performing analysis to extract, when the first text information is searched from an information search database, search information corresponding to the second text information from the search information database and extract, when the first text information is searched from a member ID database, the phone number corresponding to the member ID from the ID information database; and at a transmission section of the combined text information processing system, transmitting the search information to the user or the message to a person corresponding to the member ID according to information extracted through the analysis.

### TECHNICAL FIELD

The following description relates to a method of processing combined text information, and more particularly, to a combined text information processing method that can provide various services using a single Mobile Originated (MO) service number.

### BACKGROUND ART

Sending and receiving text messages through mobile communications has been closely associated with real life. Representative services based on text messaging are a Mobile Originated (MO) service and an information search service.

FIG. 1 is a diagram illustrating a network connection for a conventional MO service. Referring to FIG. 1, when a MO operator 120 sends a request to a communication company system 130, the communication company system 130 assigns a specific MO service number (for example, “200-0295” in the case of Traffic Broadcasting System; TBS) to the MO operator 120.

In this case, if a user 140 inputs a text message and transmits it on the MO service number assigned to the MO operator 120, the text message is provided to the MO operator 120 via the communication company system 130.

Such an interactive text messaging service is called a MO service.

Accordingly, a plurality of users can transmit text messages to a user, unlike the conventional method in which a user could transmit text messages to one or more users.

Therefore, various kinds of events using the MO service can be executed and particularly, broadcasting programs are actively introducing the MO service in order to induce TV or radio audience's participation and maximize revenue generation.

However, since in the MO service, a plurality of MO operators (for example, broadcasting programs, public institutions and financial institutions) are assigned different MO service numbers from a mobile carrier, there was inconvenience that a user needs to memorize the MO service numbers in order to transmit each text message.

Meanwhile, some of the MO operators 120 use the Mo service to provide an information search service that enables a user to search for desired information.

In the information search service, when a user 140 inputs a predetermined format of text message and sends it to a MO operator 120 to obtain desired information, the text message is transmitted to a system of the MO operator 120 via a communication company system 130 and the system of the MO operator 120 sends information corresponding to the text message sent by the user 140 in the format of a text message to the user 140.

However, since such a MO service, an information search service or the like are run by individual MO operators, there was a problem that text messages should be sent to the individual business entities.

Accordingly, in order to use such an information search service, etc., users should memorize individual MO service numbers of MO operators that can receive text messages sent by them.

### TECHNICAL PROBLEM

Therefore, the following description relates to a combined text information processing method that enables a user to use a MO service, an information search service, a member-to-member text conversation service, etc. by writing and sending combined text information on a single MO service number.

Also, the following description relates to a combined text information processing method that enables a user to receive various services by sending combined text information on a signal MO number so that he/she does not need to memorize service numbers of individual operators.

### TECHNICAL SOLUTION

According to an aspect, there is provided a method for processing combined text information, including: registering members with received member information containing member ID and corresponding phone number for message transmission; a user writing and sending a multiplicity of combined text information divided by a symbol for sectionalization at his/her terminal to a processing system; receiving the combined text information at the processing system; performing analysis on the received information with an analyzer section, the analysis including sequential matching of the multiplicity of the text information in a sectionalized state by the symbol with a database and selective extraction of information based on the matched database, forwarding the extracted information to a transmitter section; and transmitting information of interest out of the information selected and extracted by the analyzer section with the transmitter section.

In the writing and sending of the multiplicity of the combined text information, the combined text information includes first text information that is an identification factor, second text information that is an identification factor or transmission content, and a sectionalization symbol for dividing the first text information from the second text information.

In the writing and sending of the multiplicity of the combined text information, the first text information of the combined text information is any one of continuous text information or discontinuous text information.

In the performing of analysis, the matched database includes a search information database classified to match the first text information and the second text information, and an ID information database classified to match the first text information and storing ID information that includes a number corresponding to the first text information.

In the performing of analysis, the search information database is classified to match the first text information, each classified database includes an identification item matching the second text information, and the identification item stores information corresponding to the first text information and the second text information.

In the performing of analysis, the ID information database stores member IDs that are classified to match the first text information.

The performing of analysis includes: a first search operation of searching for the first text information that is an identification factor of the received combined text information from the search information database; a second search operation of searching for, when the first text information is found from the search information database, the second text information that is an identification factor from a database from which the first text information has been searched for; a third search operation of searching for, when the first text information is not found from the search information database, the first text information that is an identification factor from the ID information database; an information selection operation of selecting, when the second text information that is an identification factor is found from the database from which the first text information has been searched for, information corresponding to the second text information, and transmitting the selected information to the transmitter section; and a number selection operation of selecting, when the first text information is found from the ID information database, a number corresponding to the second text information, and transmitting the selected number to the transmitter section.

The transmitting of the information of interest includes: transmitting, when no matching information is found in the second and third search operations, a message informing that no corresponding information is found to a user who has transmitted the combined text information, and transmitting, when information matching the second text information is received in the information selection operation, the matching information to the user who has transmitted the combined text information; and setting, when a number matching to the first text information is received in the number selection operation, the number to a reception number and transmitting the second text information on the number.

The method further includes detecting continuity to determine whether the first text information among the received combined text information is continuous text information or discontinuous text information, the detecting of continuity performed between the receiving of the combined text information and the transmitting of the information of interest, wherein if the first text information is determined to be continuous text information, the first search operation is performed, and if the first text information is determined to be discontinuous text information, the third search operation is performed.

### ADVANTAGEOUS EFFECTS

Therefore, there is provided a combined text information processing method that enables a user to use a MO service, an information search service, a member-to-member text conversation service, etc. by sending combined text information on a single MO service number.

Also, there is provided a combined text information processing method that enables a user to receive various services by sending combined text information on a signal MO number so that he/she does not need to memorize service numbers of individual operators.

### DESCRIPTION OF DRAWINGS

FIG. 1 is a diagram illustrating a network connection for a conventional MO service.

FIG. 2 is a diagram illustrating a network connection for a combined text information processing system.

FIGS. 3 and 4 illustrate examples of combined text information.

FIG. 5 is a block diagram illustrating an example of a combined text information processing system.

FIGS. 6 and 7 are configuration diagrams illustrating examples of databases.

FIG. 8 is an algorithm illustrating an example of a combined text information processing method.

FIG. 9 is an algorithm illustrating another example of a combined text information processing method.

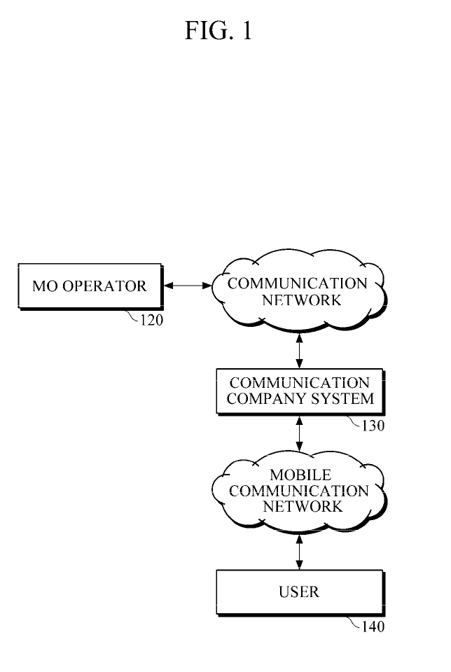

Throughout the drawings and the detailed description, unless otherwise described, the same drawing reference numerals will be understood to refer to the same elements, features, and structures. The relative size and depiction of these elements may be exaggerated for clarity, illustration, and convenience.

### MODE FOR INVENTION

In the following description, like components having the same configuration are assigned like reference numbers and described in an example, and the other examples describe configurations that are different from the first example.

Hereinafter, examples of a combined text information processing system and method will be described in detail with reference to the attached drawings.

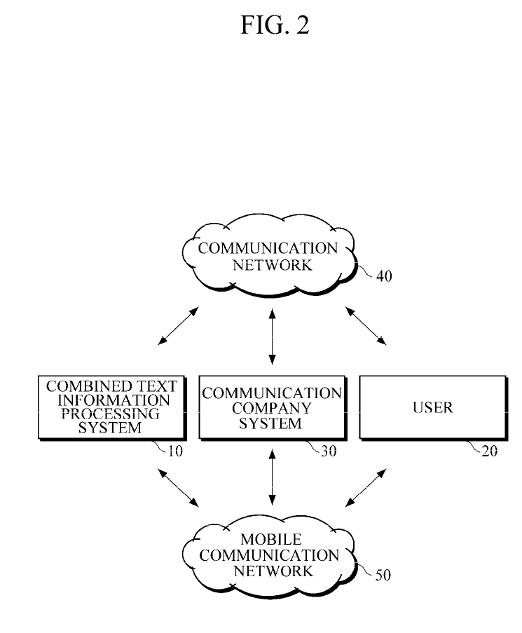

FIG. 2 is a diagram illustrating a network connection for a combined text information processing system 10. Referring to FIG. 2, the combined text information processing system 10 is used to perform a combined text information processing method according to the present invention.

In other words, the combined text information processing system 10 may be assigned a predetermined MO service number by a communication company system 30, analyze, when receiving combined text information from a user 20 through a communication network 40 or a mobile communication network 50, the combined text information, and then transmit the analyzed information to the user 20.

For this process, the combined text information processing system 10 may include a terminal. The terminal may be a terminal that is connectable to a wired/wireless Internet and includes a web browser, or a terminal that is connectable to the combined text information processing system 10 through a wired/wireless communication network and includes a controller capable of controlling a display to display content received from the combined text information processing system 10. Also, the display may be included in the terminal or may be an external image display.

Also, the combined text information processing system 10 is configured to display corrections of member information and processing history on combined text information to each member based on member IDs which the user 20 has registered.

The user 20 writes and sends combined text information using a predetermined terminal. The terminal may be a mobile phone, a personal computer (PC), etc.

When the user 20 writes combined text information and sends it on a MO service number assigned to the combined text information processing system 10, the combined text information is transmitted to the combined text information processing system 10 via the mobile communication network 50 or the communication company system 30, and the combined text information processing system 10 analyzes the combined text information and transmits the result of the analysis to the user 20.

Also, the user 20 may access the combined text information processing system 10 through the communication network 40 or the mobile communication network 50 and register members by providing member information such as member IDs and member phone numbers to the combined text information processing system 10 through a predetermined input device.

In addition, the user 20 may access the combined text information processing system 10 with his/her member ID registered to the combined text information processing system 10 to receive a my page or the like that allows the user 20 to correct member information of connected members or know processing statuses on combined text information from the connected members so that he/she can check his/her member information and a processing status on combined text information.

The communication company system 30, which provides general mobile communications or wired/wireless communications, may assign MO service numbers to the combined text information processing system 10, transmit combined text information received from the user 20 to the combined text information processing system 10 and send information received from the combined text information processing system 10 to the user 20.

The communication network 40 is located between the combined text information processing system 10, the user and the communication company system 30, to transfer data therebetween. The communication network 40 may be a wired/wireless Internet, a CDMA 1x/EV-DO mobile communication network or a Bluetooth network.

The mobile communication network 50 transmits combined text information written by the user 20 to the communication company system 30 and enables the user 20 to access the combined text information processing system 10 through the communication network 40.

Also, the mobile communication network 50 may support at least one of all existing mobile communication-related access methods including access to a Public Switched Telephone Network (PSTN), Code Division Multiple Access (CDMA), Wideband Code Division Multiple Access (WCDMA), and the like. Also, the mobile communication network 50 may be implemented to support at least one protocol among call control protocols for VoIP call connection, such as H323, Message Gateway Control Protocol (MGCP), Session Initiation Protocol (SIP) or Midia Gateway Control Protocol (Megaco).

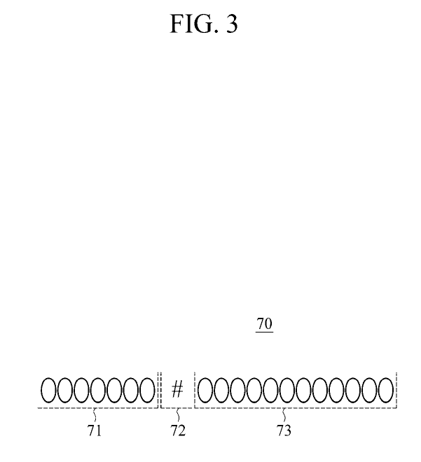

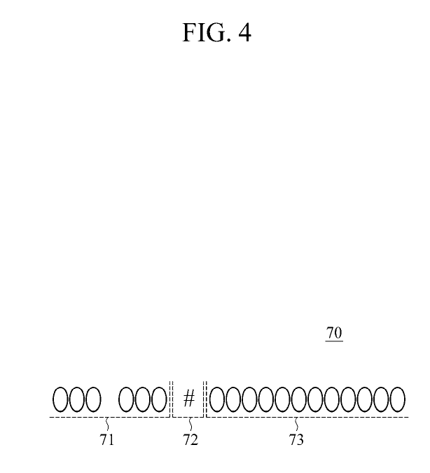

Hereinafter, examples of combined text information 70 will be described with reference to FIGS. 3 and 4.

Referring to FIGS. 3 and 4, the combined text information 70 may be written by the user 20 (see FIG. 2) in the format of a Short Message Service (SMS), a Multimedia Message Service (MMS) or the like.

The combined text information 70 may include first text information 71 and second text information 73 that are divided by a sectionalization symbol 72.

Here, the sectionalization symbol 72 is a symbol capable of distinguishing the first text information 71 from the second text information 73, and may be #, @, *, etc., which are special characters excluding Hangul and English characters that are used in a mobile device or computer.

The first text information 71 is placed before the sectionalization symbol 72 and may be used as an identification factor by which information is searched from the database of the combined text information processing system 10. Also, the first text information 71 is continuous as illustrated in FIG. 3 or discontinuous as illustrated in FIG. 4.

The second text information 73 is placed after the sectionalization symbol 72, and may be used as an identification factor by which information is searched from the database of the combined text information processing system 10 or may be content to be transmitted by a user.

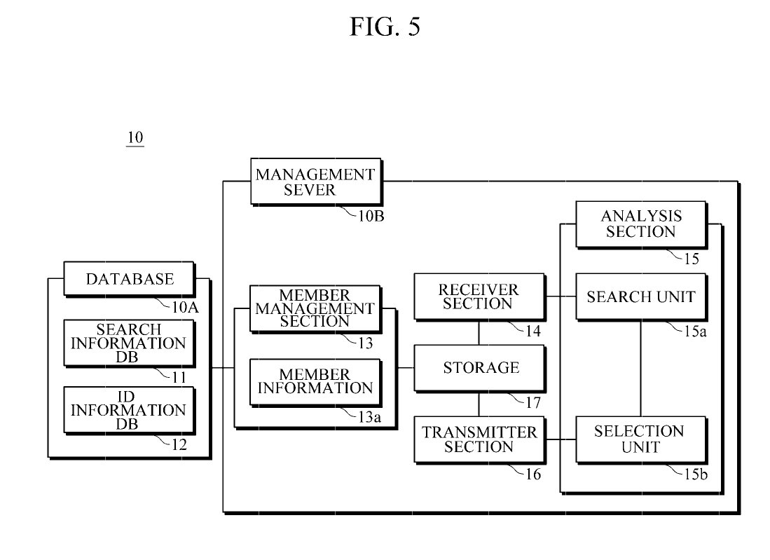

Then, the combined text information processing system 10 illustrated in FIG. 2 will be described in detail. FIG. 5 is a block diagram illustrating an example of the combined text information processing system 10.

Referring to FIG. 5, the combined text information processing system 10 may include a database 10A and a management server 10B.

The database 10A is a group of information from which the management server 10B can search for and select received combined text information 70, and may be databased to decide a service that is to be provided based on the received combined text information 70.

That is, the database 10A may include a search information DB 11 and an ID information DB 12. The search information DB 11 may classify the combined text information 70 to match first text information (for example, 71 in FIGS. 3 and 4) and second text information (for example, 73 in FIGS. 3 and 4).

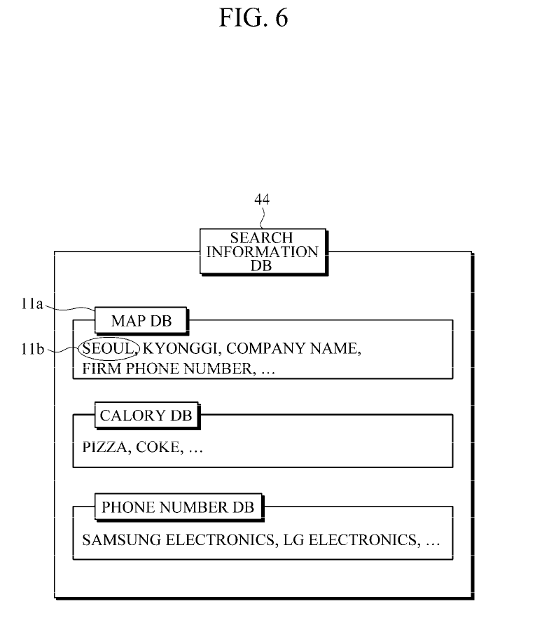

In detail, as illustrated in FIG. 6, the search information DB 11 is databased to be divided into several parent databases 11a having database names, such as a map DB, a calory DB, a coupon DB, etc., so that the first text information 71 matches the name of a parent database.

The individual parent databases 11a contain identification items 11b including region names, such as Seoul, Kyonggi, etc., food names, such as Coke, Pizza, etc., and Company names, such as Samsung Electronics, LG electronics, etc., so that the second text information 73 as an identification factor matches an identification item lib, wherein each identification item 11b may store corresponding information. If an identification item 11b included in a parent database 11a which is a map DB is Samsung Electronics, a map of Samsung Electronics may be stored in the identification item 11b.

The identification item 11b may be a phone number such as a firm phone number. Meanwhile, information that is stored as an identification item 11b may be in the format of SMS or MMS.

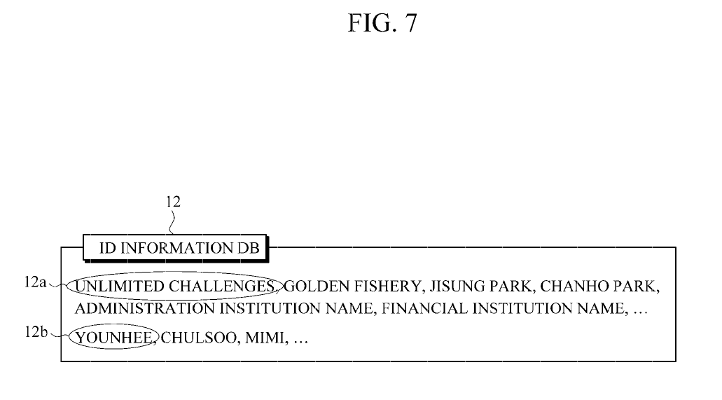

Meanwhile, as illustrated in FIG. 7, the ID information DB 12 may be databased using member IDs as identification items 12a and 12b so that a member ID matches the first text information 71 as an identification factor.

Member IDs that are identification items 12a and 12b store phone numbers of the corresponding members.

For example, member IDs that are stored as identification items 12a may include broadcasting program names, such as “unlimited changes”, “golden fishery”, etc., administration names, such as “Seoul”, “Kyonggi”, etc., financial institution names, such as “Bank of Korea”, “Kookmin Bank”, etc., sports stars' names, such as “Jisung Park”, “Chanho Park”, etc, and member IDs that are stored as identification items 12b may include member IDs of individual persons, such as “Younghee”, “Mimi”, “Chulsoo”, etc.

Now, the management server 10B will be described with reference to FIG. 5. The management server 10B may be configured to include a member management section 13, a receiver section 14, an analysis section 15, a transmitter section 16 and a storage 17.

The member management section 13 receives member information 13a including the member ID, password and phone information of the user 20 through a predetermined input device, registers the user 20 as a member and stores the member information 13a.

The member information is stored in the ID information DB 12 of the database 10A and the member ID as an identification item contains a member phone number, which has been described above. The member phone number may be a mobile phone number or an arbitrary phone number allowing message reception and transmission.

Also, the member management section 12 may be configured to store combined text information transmitted from or received by each registered member in member information 13a of the corresponding member.

In other words, when a registered member accesses the combined text information processing system 10 with his/her member ID to receive a predetermined page such as my page, the member management section 12 enables the member to correct his/her member information or check a processing history on combined text information which he/she has transmitted or received.

The receiver section 14 is configured to receive combined text information 70 sent by the user 20 and transmit the combined text information 70 to the analysis section 15.

The analysis section 15 may include a search unit 15a and a selection unit 15b. The analysis unit 15 recognizes a sectionalization symbol 72 out of the received combined text information and divides the first text information 71 from the second text information 73 based on the sectionalization symbol 72.

First, the search unit 15a receives the combined text information 70 from the receiver section 14 and searches for a database using the first or second text information 71 or 73 of the combined text information 70 as an identification factor.

At this time, the search unit 15a may recognize, when the first text information 71 is continuous text information, the first text information 71 as a single piece of information and when the first text information 71 is discontinuous text information, that is, when the first text information 71 contains at least one space (blank), each piece of information disposed before and after the space (blank) as individual information.

The selection unit 15b selects information corresponding to the first and second text information 71 and 73 from the matched database, and selects the first and second text information 71 and 73 used as identification factors of the received combined text information 70 and transfers the selected information to the transmitter section 16.

That is, the selection unit 15b compares the first text information 71 used as an identification factor by the search unit 15a to the parent databases 11a of the search information DB 11. If a parent database 11a matching the first text information 71 is found, the search unit 15a recognizes the second text information 73 as an identification factor and compares the second text information 73 to identification items 11b of the parent database 11a using the second text information 73 as an identification factor. If an identification item 11b matching the second text information 73 is found, information included in the found identification item 11b is selected and transmitted to the transmitter section 16.

Also, if no information matching the first text information 71 used as an identification factor is found in the search information DB 12, information matching the first text information 71 is searched from the ID information DB 12. If the first text information 71 is a discontinuous string with at least one blank, strings before and after the blank are recognized as individual pieces of information and it is determined whether information matching each piece of information exists in the ID information DB 12.

If an identification item matching the first text information 71 is found in the ID information DB 12, the selection section 15b selects a number (a phone number registered upon member registration) included in the matched identification item, recognizes and selects the second text information 73 as content that is to be transmitted on the selected phone number, then selects the first text information 71, that is, a member ID and transmits the member ID to the transmitter section 16.

If the information selected and transmitted by the analysis section 15 contains a number, the transmitter section 16 sets the number to a reception number, sets the second text information 73 to content to be transmitted and uses a predetermined algorithm to transmit the second text information 73 together with a member ID of the user 20 who has transmitted the combined text information 70.

Meanwhile, if the information selected and transmitted by the analysis section 15 includes no number, that is, if the information is information for searching, the transmitter section 16 returns the information to the user 20 who has transmitted the combined text information 70.

Also, when receiving a message informing that no corresponding information is found from the analysis section 15, the transmitter section 16 returns the message informing that no corresponding information is found to the user 20 who has transmitted the combined text information 70.

Meanwhile, the storage 17 is connected to the member management section 13 and the receiver section 14, uses a predetermined algorithm to search for the member ID that has transmitted the combined text information 70 from the member management section 13 and then stores the combined text information 70 in member information 13a of the corresponding member.

Likewise, the storage 17 is connected to the member management section 13 and the transmitter section 16, and uses a predetermined algorithm to store content transmitted from the transmitter section 16 and the corresponding member ID or found content and the corresponding member ID, etc. in member information 13a.

In this way, by storing received combined text information 70 in corresponding member information and storing content processed by and transmitted from the combined text information processing system 10, each member may access the combined text information processing system 10 with his/her member ID and view my page to check processing histories on combined text information that he/she has transmitted and received.

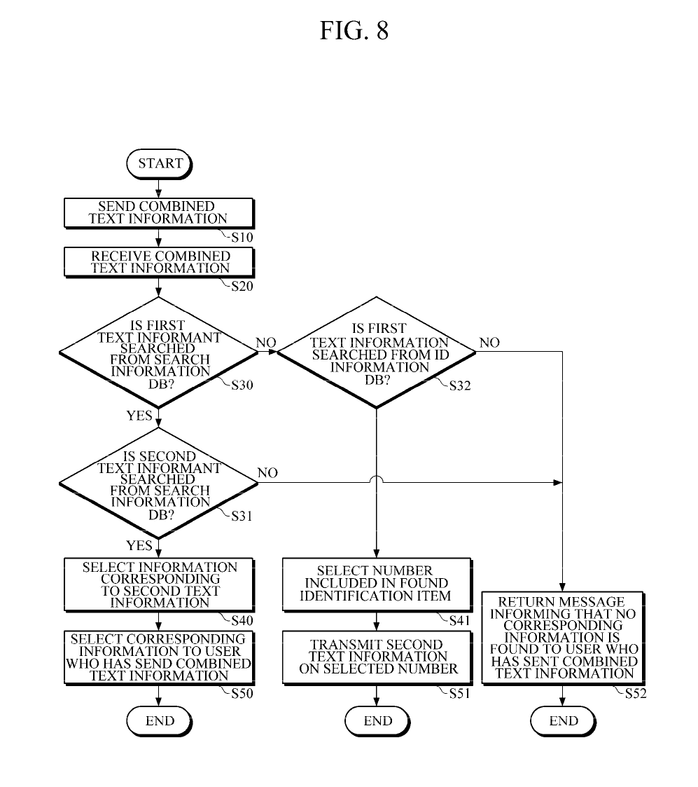

Hereinafter, an example of a combined text information processing method which is performed by the combined text information processing system 10 illustrated in FIG. 5 will be described with reference to FIG. 8.

FIG. 8 is an algorithm illustrating an example of a combined text information processing method.

It is assumed that the combined text information processing system 10 which is a system of a MO operator is assigned a specific MO service number (for example, “#1234”) from the communication company system 30, and the user 20 is registered as a member through the member management section 13 of the management server 10B by accessing the combined text information processing system 10 through the mobile communication network 50 to input member information 13a including a member ID, a password, a phone number, etc.

Referring to FIG. 8, according to the combined text information processing method, in order to receive a desired service, a user writes predetermined combined text information 70 divided by a sectionalization symbol 72 and sends the combined text information 70 using a MO service number as a reception number, wherein the MO service number has been assigned to the combined text information processing system 10 from the communication company system 30 (S10).

The combined text information 70 sent by the user 20 is transmitted to the communication company system 30 through the mobile communication network 50 or the communication network 40, and the communication company system 30 transmits the combined text information 70 to the combined text information processing system 10 corresponding to the MO service number.

Successively, the combined text information 70 is transferred to the receiver section 14 of the management server 10B of the combined text information processing system 10 and the receiver section 14 transfers the combined text information 70 to the analysis section 15 (S20).

The search unit 15a of the analysis section 15 performs a first search operation of using first text information 71 of the combined text information 70 as an identification factor to determine whether a parent database name matching the first text information 71 exists in the search information DB 11 of the database 10A (S30).

If no parent database name matching the first text information 71 is found in the search information DB, the search unit transmits a message informing that no corresponding information is found to the transmitter section.

Then, if a parent database name matching the first text information 71 is found in the search information DB 11, the search unit 15a performs a second search operation of using second text information 73 of the combined text information 70 as an identification factor to determine whether an identification item matching the second text information 73 exists in the found database (S31).

Successively, at an information section operation, when an identification item matching the second text information 73 is found, the selection section 15b selects information included in the found identification item, also selects the first and second text information 71 and 73 of the combined text information 70 and transfers the selected information to the transmitter section 16 (S40).

If at the first search operation, no parent database name matching the first text information 71 is found in the search information DB 11, the search unit 15a performs a third search operation of using the first text information 71 as an identification factor to determine whether information matching the first text information 71 exists in the ID information DB 12 (S32).

Then, at a number selection operation, if an identification item matching the first text information 71 is found in the ID information DB 12, the selection unit 15b selects a number included in the identification item, recognizes and selects the second text information 73 as content to be transmitted and transfers the selected information to the transmitter section 16 (S41). If no identification item matching the first text information 71 is found, the selection unit 15b transfers a message informing that no corresponding information is found to the transmitter section 16.

Next, if the information received from the analysis section 15 includes no number, that is, if the information is information for searching, the transmitter section 16 returns the information to the user 20 who has sent the combined text information 70 (S50).

Also, if a number is included in the information received from the analysis section 15, the transmitter section 16 sets the number to a reception number, sets the second text information 73 to content to be transmitted, and uses a predetermined algorithm to transmit the second text information 73 together with a member ID of the user 20 who has sent the combined text information 70 (S51).

If receiving a message informing that no corresponding information is found from the search section 15a, the transmitter section 16 returns a predetermined message such as “no corresponding information is found” to the user 20 who has sent the combined text information 70 (S52).

Meanwhile, the storage 17 stores combined text information 70 received by the receiver section 14 or transmitted from the transmitter section 16 in member information 13a of the corresponding member ID.

In this way, a service is provided according to a database that is selected by the selection section 15b.

Now, services that can be provided to the user 20 according to the combined text information processing method described above will be described with reference to FIGS. 5 through 8.

First, it is assumed that the combined text information processing system 10 is assigned a MO service number “#1234”, the database 10A of the combined text information system 10 is established as illustrated in FIGS. 6 and 7, broadcasting program names, such as “unlimited changes”, “golden fishery”, etc., sports stars' names, such as “Jisung Park”, “Chanho Park”, etc., and various administration names and financial institution names are registered as user member IDs, and “Younghee”, “Chulsoo”, “Mimi”, etc. are registered as member IDs of individual users through the communication network 40 or the mobile communication network 50.

1) In the Case of a Search Service.

When a user 20 whose member ID is “Chulsoo” tries to use a search service, combined text information 70 may be transmitted in the format of “search word#search word”.

In the combined text information 70, # is a sectionalization symbol, a “search word” placed before the sectionalization symbol # is first text information 71 and “search word” placed after the sectionalization symbol # is second text information 73. Each “search words” can be used as an identification factor upon database searching of the combined text information processing system 10.

For example, when Chulsoo tries to search for a map of the Seoul city, combined text information 70 is written in the format of “Map#Seoul” and transmitted on the reception number “#1234” that is the MO service number of the combined text information processing system 10.

The combined text information 70 in which “#1234” has been set to the reception number is transmitted to the combined text information processing system 10 by the communication company system 30. The receiver section 14 of the combined text information processing system 10 receives the combined text information 70 and the search unit 15a of the analysis section 15 uses “map” which is first text information 71 of the combined text information 70 as an identification factor to search for information corresponding to the “map” from the search information DB 11.

In the current example, since the “map” matches the name of the map DB 11a, the search unit 15a uses “Seoul” which is second text information 73 as an identification factor to search for a corresponding identification item from the map DB 11a. Also, since an identification item “Seoul” exists in the map DB 11a, the selection unit 15b selects information included in the identification item “Seoul”.

The selection unit 15b selects map information of the Seoul city and transfers it to the transmitter section 16, and the transmitter section 16 returns the map information of the Seoul city to the user 20 who has sent the combined text information 70.

Likewise, it is also possible that Chulsoo receives desired information, for example, a firm phone number, through database search using second text information “Firm Phone Number”, by setting “#1234” to a reception number and writing combined text information 70 in the format of “Map#Firm Phone Number”, as described above.

In the same way, when Chulsoo sets “#1234” to a reception number and transmits combined text information 70 in the format of “Calory#Pizza”, the combined text information 70 is transmitted to the combined text information processing system 10 via the communication company system 30.

Then, the combined text information processing system 10 matches first text information “Calory” to “Calory DB”, second text information “Pizza” to an identification item “Pizza”, then selects the corresponding information and returns the selected information to Chulsoo, so that Chulsoo acquires information about calories of Pizza.

Also, when Chulsoo sets “#1234” to a reception number and transmits combined text information in the format of “Phone Number#Samsung Electronics”, the combined text information processing system 10 matches first text information “Phone Number” to “phone number DB”, second text information “Samsung Electronics” to an identification item “Samsung Electronics”, then selects the corresponding information and returns the selected information to Chulsoo, so that Chulsoo acquires information about a phone number of Samsung Electronics.

Meanwhile, Chulsoo can check combined text information which he has transmitted or received by using his member ID “Chulsoo” to access the combined text information processing system 10 through the communication network 40 or the mobile communication network 50 and then viewing my page provided through the member management section 13 of the combined text information processing system 10.

2) Text Transmission and Member-to-Member Text Conversation Service

It is assumed that for text transmission and a member-to-member text conversation service, a database is established as in FIGS. 6 and 7, like the search service described above.

When “Younghee” tries to transmit a predetermined message to a broadcasting program “Unlimited Challenges”, she may write combined text information 70 in the format of “Unlimited Challenges#Transmission Content” and set “#1234” to a reception number.

The receiver sector 14 receives the combined text information 70 “Unlimited Challenges” and the search unit 15a of the analysis section 15 uses first text information “Unlimited Challenges” as an identification factor to match the first text information “Unlimited Challenges” to a parent database name of the search information DB 11. Since no parent database name matching “Unlimited Challenges” is found, the search unit 15a uses “Unlimited Challenges” as an identification factor to search for corresponding information from the ID information DB 12.

Since an identification item matching “Unlimited Challenges” is found in the ID information DB 12, the selection unit 15b selects a phone number included in the “Unlimited Challenges” and “Transmission Content” that is second text information 73 and transfers the selected information to the transmitter section 16.

The transmitter section 16 sets the phone number of the “Unlimited Challenges” to a reception number, sets the “Transmission Content” to a message and transmits the selected information.

At this time, the transmission section 16 may run a predetermined algorithm to match a transmission number on which the combined text information 70 has been transmitted and transmit the member ID “Younghee” together with the “Transmission Content”.

Likewise, when Younghee writes combined text information 70 in the form of “Financial Institution Name#Transmission Content”, “Administration Institution Name#Transmission Content”, and “Sports Star Name#Transmission Content”, etc., and transmits the combined text information 70 on a reception number “#1234” to members registered as member IDs, such as a “Financial institution name”, an “administration institution name”, a “sports star name”, etc., a message is transmitted to the corresponding members by the above-described method.

Meanwhile, when Younghee tries to transmit a predetermined message to a member ID “Chulsoo”, Younghee may write combined text information 70 in the form of “Chulsoo#Transmission Content”, set “#1234” to a reception number and transmit the combined text information 70 on the reception number “#1234”.

The combined text information 70 sent by Younghee is transmitted to the combined text information processing system 10 corresponding to the “#1234” via the communication company system 30.

The receiver section 14 of the combined text information processing system 10 receives the combined text information 70, the search unit 15a of the analysis section 15 uses “Chulsoo” which is first text information 71 of the combined text information 70 as an identification factor to search for a corresponding parent database name from the search information DB 11. In the current example, since no database parent data name matching “Chulsoo” is found in the search information DB 11, the search unit 15a uses “Chulsoo” as an identification factor to search for corresponding information from the ID information DB 12.

Since an identification item matching “Chulsoo” is found in the ID information DB 12, the selection unit 15b selects a phone number included in the identification item “Chulsoo” and “Transmission Content” that is second text information 73 and transmits the selected information to the transmitter section 16.

The transmitter section 16 sets the phone number of “Chulsoo” to a reception number and “Transmission Content” to a message and transmits them. Also, the transmitter section 16 may run a predetermined algorithm to match a transmission number on which the combined text information 70 has been transmitted and transmit the “Transmission Content” together with the member ID “Younghee”.

As a result, the user 20 having the member ID “Chulsoo” can receive a message in which the “Transmission Content” and the member ID “Chulsoo” are included. In the same way, the user 20 having the member ID “Chulsoo” may send a replay in the format of “Youghi#Transmission Content” to start a text conversation with Younghee. In this way, a member-to-member text conversation can be performed only with member IDs.

As described above, it is possible to use a conventional MO service, various search services, text transmission, member-to-member text conversation, etc. with “#1234” that is a single MO service number.

Also, like the search service, Chulsoo, Mimi or Younghee may access the combined text information processing system with his/her member ID through the communication network or the mobile communication network and view my page provided through the member management section of the combined text information processing system, thereby checking combined text information which he/she has transmitted or received.

Accordingly, by transmitting a predetermined format of combined text information to the combined text information processing system which has been assigned a predetermined MO service number by the communication company system, the combined text information processing system analyzes the combined text information according to the combined text information processing method and provides a corresponding service according to information selected by the selection unit based on a database.

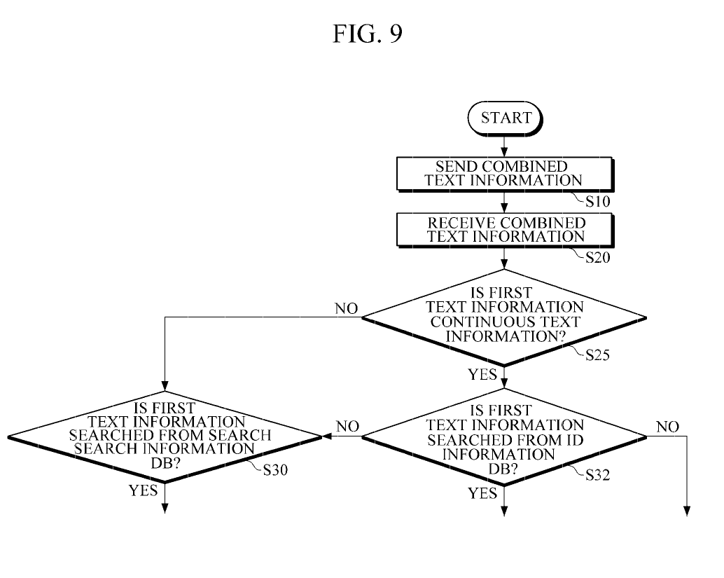

Hereinafter, another example of a combined text information processing method will he described with reference to FIG. 9. FIG. 9 is an algorithm illustrating another example of a combined text information processing method.

Referring to FIG. 9, the combined text information processing method is performed between the operations S20 and S30 of the example illustrated in FIG. 8, and further includes operation S25 of determining whether the first text information 71 is continuous.

When first text information 71 of the combined text information 70 is discontinuous text information as illustrated in FIG. 4, that is, when the first text information 71 includes at least one space (blank), the search unit 15a recognizes each piece of information disposed before and after the space (blank) as individual information.

Meanwhile, when the first text information 71 is determined to be continuous text, the first search operation described above with reference to FIG. 8 is performed, and when the first text information 71 is determined to be discontinuous text, the third search operation described above with reference to FIG. 8 is performed.

Since the first text information 71 has individual information, matching is performed according to the individual information.

For example, it is assumed that the database of the combined text information processing system 10 is established as illustrated in FIG. 7 and users 20 are registered with member IDs of “Younghee”, “Chulsoo” and “Mimi” through the mobile communication network 50 (see FIG. 5). In this case, if a user “Younghee” tries to transmit a predetermined message to another user having the member ID “Chulsoo”, combined text information 70 may be transmitted in the format of “Chulsoo Mimi#Transmission Content”.

The search unit 15a receives the combined text information 70 from the receiver section 14. First text information 71 of the combined text information 70 is “Chulsoo Mimi”.

Accordingly, since the first text information 71 is discontinuous text information, the analysis section 15 recognizes “Chulsoo” and “Mimi” as individual information and searches for and selects corresponding information from the ID information DB 12, thereby transmitting “Transmission Content” that is second text information 73 to the users “Chulsoo” and “Mimi”. When the users “Chulsoo” and “Mimi” that have received a message including “Transmission Content” and a member ID “Younghee” send “Younghi#Transmission Content”, a member-to-member text conversation is started. That is, by once transmitting combined text information 70, a member-to-member text conversation can be started.

As described above, unlike the conventional technique in which a user should memorize MO service numbers assigned by a communication company system in order to use each service, the combined text information processing method according to the above-described examples enables a user to use various services through a single MO service number.

In addition, although in the above example, the case where analyzed content according to combined text information is transmitted on a number stored in corresponding member information has been described, it is also possible that a predetermined algorithm is applied to transmit transmission content according to analyzed combined text information on E-mail, etc. of member information.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### INDUSTRIAL APPLICABILITY

Transmission of short or long text messages using computers or mobile terminals became a lifestyle pattern.

A user can use such text messages to transmit certain messages to another party or acquire desired information from another party. Such a service has been provided through individual and independent text messages.

However, according to the combined text information processing method of the present invention, a user can use various services, such as MO services, information search services, member-to-member text conversion services, etc. by writing combined text information and sending it on a single service number.

In other words, by analyzing combined text information that is sent on a single service number by a user, various kinds of services can be provided to the user, resulting in implementation of an incorporated service.

1-9. (canceled)

10. A combined text information processing method comprising:
at a combined text information processing system, registering a member by receiving member information containing a member ID and a phone number for message transmission on the member ID;
at a user, sending combined text information to the combined text information processing system through a network, wherein the combined text information is composed of first text information that is a search word or the member ID, second text information that is a search word or a message, and a symbol for sectionalization between the first and second text information;
at a receiver section of the combined text information processing system, receiving the combined text information;
performing analysis to extract, when the first text information is searched from a search information database, search information corresponding to the second text information from the search information database and extract, when the first text information is searched from a member ID database, the phone number corresponding to the member ID from the ID information database, wherein the search information database and the ID information database are included in a database of the combined text information processing system, the search information database stores a multiplicity of search information and the ID information database stores the member ID and the phone number corresponding to the member ID; and
at a transmission section of the combined text information processing system, transmitting the search information to the user or the message to a person corresponding to the member ID according to information extracted through the analysis.

11. The combined text information processing method of claim 10, wherein the search information database is sectioned to one or more parent databases whose names match the first text information, each parent database including an identification item that matches the second text information and stores information corresponding to the second text information.

12. The combined text information processing method of claim 10, wherein the transmitting of the search information or the message comprises:
transmitting, when the first text information is searched from the search information database, the search information extracted from the search information database to the user that has sent the combined text information;
transmitting, when the first text information is searched from the member ID database, the second text information to a user corresponding to the member ID on a phone number of the member ID extracted from the member ID database; and
transmitting, when the first text information is not searched from the search information database or the member ID database, a message informing that no corresponding information is found to the user that has sent the combined text information.

13. The combined text information processing method of claim 10, wherein the first text information is one of a string without a blank and a string with at least one blank.

14. The combined text information processing method of claim 13, further comprising before the performing of the analysis after the receiving of the combined text information, detecting continuity by determining whether the first text information of the received combined text information is a string without a blank or a string with at least one blank,
wherein when the first text information is a string without a blank, the first text information is searched from the search information database at the performing of the analysis and when the first text information is a string with at least one blank, the first text information is searched from the member ID database at the performing of the analysis.
